(19) United States
(12) Patent Application Publication
(10) Pub. No.: US 2026/0297227 A1
(43) Pub. Date: Oct. 1, 2026

(54) LOW ETHYLENE CONTENT RANDOM PROPYLENE-BASED COPOLYMER COMPOSITIONS AND METHODS RELATED THERETO

(71) Applicant: EXXONMOBIL CHEMICAL PATENTS INC., Baytown, TX (US)

(72) Inventors: Xuejia YAN, Manvel, TX (US); Syamal TALLURY, Houston, TX (US); Ranadip GANGULY, Houston, TX (US)

(73) Assignee: EXXONMOBIL CHEMICAL PATENTS INC., Baytown, TX (US)

(21) Appl. No.: 19/090,000

(22) Filed: Mar. 25, 2025

(51) Int. Cl. C08F 210/06

(52) U.S. Cl. CPC C08F 210/06

(57) ABSTRACT

Compositions, methods, and molded articles including an ethylene/propylene random copolymer composition comprising an ethylene content of from about 0.1 wt. % to about 0.47 wt. %, a molecular weight distribution of from about 5 to about 20, a plaque haze of from about 10% to about 35%, and a flexural modulus of from ab out 250 kpsi to about 350 kpsi.

### FIELD OF THE INVENTION

The present disclosure relates to low ethylene content propylene-based random copolymer compositions and methods related thereto, and more particularly, to low ethylene content propylene-based random copolymer compositions having improved strength and toughness while retaining clarity and methods related thereto.

### BACKGROUND OF THE INVENTION

Polypropylene is one of the most widely used thermoplastics for a variety of applications because of its superior physical properties. In particular, polypropylene exhibits excellent properties as compared with other polyolefins in terms of chemical resistance to organic solvents, tensile strength, and ease of processability, for example. Conventional uses of polypropylene include packaging products (molded articles), such as food containers, beverage containers, storage containers, plastic jars, lids and covers related thereto, among others. These packaging products are often desirably rigid, such that they can be formed into different shapes suited for a specific application and maintain such shape. Further, such packaging products often desirably feature high clarity (low-haze), making it easy to view the packaged item.

However, polypropylene specimens can be quite brittle and can thus exhibit undesirable mechanical performance, particularly for use in packaging products. As such, polypropylene is generally compounded with elastomeric polymers, such as ethylene, to form random copolymers having improved impact strength and toughness. Ethylene content in polypropylene copolymers is used for product packaging because of such impact strength and toughness, as well as other advantages, including favorable heat sealing characteristics. However, unwanted side effects can result as ethylene content increases, such as a high amount of extractables leading to processing difficulties and restrictions in food and medical packaging product applications. Certain of these processing difficulties, such as an increased propensity of oligomer/additive migration, can cause visible signs of blooming that result in a negative impact on clarity

Accordingly, there is a need for a low ethylene content ethylene/propylene copolymer that has favorable strength and toughness without impacting clarity for use in rigid packaging products.

### SUMMARY

The present disclosure relates to low ethylene content propylene-based random copolymer compositions and methods related thereto, and more particularly, to low ethylene content propylene-based random copolymer compositions having improved strength and toughness while retaining clarity and methods related thereto.

A nonlimiting example of one or more aspects of the present disclosure includes a composition comprising an ethylene/propylene random copolymer. The ethylene/propylene random copolymer includes an ethylene content of from about 0.1 wt. % to about 0.47 wt. %, a molecular weight distribution of from about 5 to about 20, a plaque haze of from about 10% to about 35%, and a flexural modulus of from about 250 kpsi to about 350 kpsi.

A nonlimiting example of one or more aspects of the present disclosure includes method of polymerizing ethylene and propylene monomers to produce an ethylene/propylene random copolymer. The ethylene/propylene random copolymer includes an ethylene content of from about 0.1 wt. % to about 0.47 wt. %, a molecular weight distribution of from about 5 to about 20, a plaque haze of from about 10% to about 35%, and a flexural modulus of from about 250 kpsi to about 350 kpsi.

A nonlimiting example of one or more aspects of the present disclosure includes a molded article comprising an ethylene/propylene random copolymer. The ethylene/propylene random copolymer includes an ethylene content of from about 0.1 wt. % to about 0.47 wt. %, a molecular weight distribution of from about 5 to about 20, a plaque haze of from about 10% to about 35%, and a flexural modulus of from about 250 kpsi to about 350 kpsi.

### DETAILED DESCRIPTION OF THE INVENTION

The present disclosure relates to low ethylene content propylene-based random copolymer compositions and methods related thereto, and more particularly, to low ethylene content propylene-based random copolymer compositions having improved strength and toughness while retaining clarity and methods related thereto.

As discussed above, ethylene/propylene random copolymers can be effectively used for the manufacture of packaging products, particularly rigid packaging products, but may suffer from a tradeoff between strength/toughness and clarity. The present disclosure alleviates the foregoing difficulties and provides related advantages as well. In particular, the present disclosure provides an improvement in strength and toughness of ethylene/propylene random copolymers by capitalizing on a broad molecular weight distribution thereof, which allows a reduction in ethylene content and thus improved clarity.

Illustrative aspects of the present disclosure include ethylene/propylene random copolymers, methods of producing the same, and packaging products produced therefrom.

### Definitions and Test Methods

All numerical values within the detailed description and the claims herein are modified by “about” or “approximately” with respect to the indicated value, and take into account experimental error and variations that would be expected by a person having ordinary skill in the art. Unless otherwise indicated, ambient temperature (room temperature or “RT”) is about 25° C.

As used in the present disclosure and claims, the singular forms “a,” “an,” and “the” include plural forms unless the context clearly dictates otherwise.

The term “and/or” as used in a phrase such as “A and/or B” herein is intended to include “A and B,” “A or B,” “A,” and “B.”

For the purposes of the present disclosure and the claims thereto, the following definitions shall be used.

As used herein, a “copolymer,” and grammatical variants thereof, is comprised of polymerized co-monomers of propylene and ethylene. The copolymers described herein are “random copolymers,” in which ethylene monomer residues are randomly located within a polypropylene polymer. As used herein, the term “co-polypropylene polymer” will refer to a random copolymer of propylene and ethylene.

As used herein, the term “melt flow rate” or “MFR,” and grammatical variants thereof, is the number of grams extruded in 10 minutes under the action of a standard load and is an inverse measure of viscosity. A high MFR implies low viscosity and low MFR implies high viscosity. In addition, the copolymers described herein are shear thinning, which means that their resistance to flow decreases as the shear rate increases. This is due to molecular alignments in the direction of flow and disentanglements. As provided herein, MFR (12, 230° C., 2.16 kg) is determined according to ASTM D-1238-E(20) and is measured in grams per minute (g/min).

The term “melt temperature” or “Tm,” and grammatical variants thereof, refers to a copolymer melt temperature at an extruder die, which has units of ° C., unless otherwise specified.

The term “crystallization temperature” or “Tc,” and grammatical variants thereof, refers to the temperature at which transition from an amorphous-liquid state of a copolymer melt to a crystalline state, and has units of ° C., unless otherwise specified.

As used herein, the term “plaque haze,” and grammatical variants thereof, refers to the scattering of light as it passes through the co-polypropylene polymers of the present disclosure. The plaque haze is determined according to ASTM D1003B-21 based on 1 mm plaque thickness.

The term “flexural modulus,” and grammatical variants thereof, refers to the tendency of a material to bend in terms of a ratio of stress to strain and is determined according ASTM D790A-17. Flexural modulus has units of kilo-pounds per-square-inch (kpsi).

The term “tensile strength,” and grammatical variants thereof, refers to the plastic strength specifications of unreinforced and reinforced polymers. The test methods uses standard dogbone-shaped specimens under 14 millimeters of thickness and is performed according to ASTM D638-22. Tensile strength has units of pounds per-square-inch (psi).

As used herein, the term “Notched Izod,” and grammatical variants thereof, refers to a measure of impact resistance from a swinging pendulum; it is a degree of kinetic energy needed to initiate a fracture in a material and continue the fracture until the material is broken. Notched Izod is determined according to ASTM D256A-10 and measured in units of foot pound per inch (ft-lb/in).

As used herein, “Mₙ” is number average molecular weight and “M_{w}” is weight average molecular weight. Unless otherwise noted, all molecular weight units (e.g., M_{w} and Mₙ), including molecular weight data are in the unit of kilograms per mol (kg/mol). Molecular weight was tested according to the GPC-4D method.

As used herein, the term “molecular weight distribution” or “MWD,” and grammatical variants thereof, is equivalent to the expression M_{w}/Mₙ and is also referred to as polydispersity index (PDI). The expression M_{w}/Ma is the ratio of the M_{w} to the Mₙ. The M_{w} is given by:

$${M}_{w} = \frac{{\sum }_{i} {n}_{i} {M}_{i}^{2}}{{\sum }_{i} {n}_{i} {M}_{i}}$$

The Mₙ is given by:

$${M}_{n} = \frac{{\sum }_{i} {n}_{i} {M}_{i}}{{\sum }_{i} {n}_{i}}$$

where nᵢ in the foregoing equations is the number fraction of molecules of molecular weight Mᵢ.

As used herein, the term “ethylene percentage” or “C2%,” and grammatical variants thereof, refers to the percentage of ethylene included in a co-polypropylene polymer.

As used herein, the terms “slurry polymerization,” “slurry,” and “slurry polymerization reactor,” and grammatical variants thereof, each refer to a process where an olefin (e.g., propylene) is partly dissolved or not dissolved in the polymerization medium, During slurry polymerization, catalyst components, solvent, a-olefins, and hydrogen can be passed under pressure to one or more slurry polymerization reactors. Typically, catalyst components are fed to the slurry polymerization reactor as a mixture in aliphatic hydrocarbon solvent, in oil, a mixture thereof, or as a dry powder.

The term “extruder,” and grammatical variants thereof, as used herein, includes any machine suitable for polyolefin extrusion. For example, the term includes machines that can extrude polyolefin in the form of powder or pellets, sheets, fibers, or other shapes and/or profiles, without limitation. Generally, an extruder operates by feeding polymeric material through the feed throat which comes into contact with one or more rotating screws. The rotating screw(s) force the polyolefin forward into one or more heated barrels. In some processes, a heating profile can be set for the barrel in which one or more (e.g., three or more) independent proportional-integral-derivative controller (PID)-controlled heater zones can gradually increase the temperature of the barrel. The extruder may be a single-screw or twin-screw extruder.

### Co-Polypropylene Random Copolymer, Methods, and Systems

Compositions and methods for producing co-polypropylene polymers include the preparation of co-polypropylene polymers compositions having low ethylene content having broad MWD demonstrating enhanced flexural modulus values (stiffness) and tensile strength without compromising plaque haze (clarity).

Compositions and methods disclosed herein include the preparation of co-polypropylene polymer compositions by polymerization having a broad MWD and enhanced strength and toughness while retaining clarity. Co-polypropylene polymer compositions disclosed herein may include a mixture of a polypropylene polymer and a second polyethylene polymer in a low concentration, as described herein.

The co-polypropylene polymers of the present disclosure may have an ethylene content of less than about 0.47 wt. %, such as less than about 0.46 wt. %, or in the range of about 0 wt. % to about 0.47 wt. %, encompassing any value and subset therebetween.

The co-polypropylene polymers of the present disclosure may have a flexural modulus of greater than about 250 kpsi, such as in the range of about 250 kpsi to about 350 kpsi, encompassing any value and subset therebetween.

The co-polypropylene polymers of the present disclosure may have a tensile strength in the range of greater than about 5500 psi, such as greater than about 5600 psi, or in the range of about 5500 psi to about 6500 psi, encompassing any value and subset therebetween.

The co-polypropylene polymers of the present disclosure may have a plaque haze of less than about 35%, such as in the range of about 10% to about 35%, or about 30%, based on a 1 mm thickness sample, encompassing any value and subset therebetween.

The co-polypropylene polymers of the present disclosure may have a MFR at 230° C. in the range of from about 2 g/10 min to about 100 g/10 min, encompassing any value and subset therebetween.

The co-polypropylene polymers of the present disclosure may have a melt temperature (Tm) in the range of about 150° C. to about 170° C., encompassing any value and subset therebetween.

The co-polypropylene polymers of the present disclosure may have a crystallization temperature (Tc) of from about 100° C. to about 140° C., encompassing any value and subset therebetween.

The co-polypropylene polymers of the present disclosure described herein have a molecular weight (Mw) of from about 300 kg/mol to about 700 kg/mol, such as about 350 kg/mol to about 600 kg/mol, or about 350 kg/mol to about 500 kg/mol, encompassing any value and subset therebetween.

The co-polypropylene polymers of the present disclosure may have a MWD of from about 5 to about 20, such as about 5 to about 16, or about 7 to about 16, encompassing any value and subset therebetween.

The co-polypropylene polymers of the present disclosure may have a Notched Izod impact value at 23° C. of from about 0.5 ft-lb/in to about 1 ft-lb/in, such as about 0.8 ft-lb/in to about 0.9 ft-1b/in, encompassing any value and subset therebetween. Methods disclosed herein may include single-stage or multi-stage polymerization processes having a first stage in which a polypropylene polymerization reaction produces a first polypropylene and a second stage that produces a second polyethylene polymer. The two polymers may be co-extruded to form the co-polypropylene polymers of the present disclosure. In one or more aspects, the co-extrusion compounding may be achieved using a screw extruder, such as a ZSK 45 Mc¹⁸ screw extruder (Coperion, Stuttgart, Germany).

Processes described herein may be used in combination with other techniques to tune strength and toughness without compromising clarity, including post-reactor modification by crosslinking or blending with other additives, such as antioxidants.

A method for preparing the co-polypropylene polymer compositions of the present disclosure may include polymerizing propylene and ethylene with a non-phthalate Ziegler-Natta catalyst system to form the ethylene/propylene random copolymer composition, and extruding the ethylene/propylene random copolymer composition to form the co-polypropylene polymer composition.

Various Ziegler-Natta pro-catalysts may be used in the non-phthalate catalyst system, although other catalyst systems for polymerizing propylene and ethylene may be used, without departing from the scope of the present disclosure. For example, the Ziegler-Natta procatalyst composition may include a transition metal compound and a Group 2 metal compound. The transition metal compound may include a solid complex derived from a transition metal compound, such as, titanium-, zirconium-, chromium- or vanadium-hydrocarbyloxides, hydrocarbyls, halides, or mixtures thereof. In one or more aspects, the Ziegler-Natta procatalyst composition comprises a titanium transition metal, a magnesium Group 2 metal, and a chloride halogen.

The polymerization process comprises polymerizing ethylene (in low concentration) and propylene in the presence of the non-phthalate catalyst system under reaction conditions sufficient to form the co-polypropylene polymer compositions of the present disclosure.

Any kind of polymerization process suitable for preparing a polyolefin can be used with the catalyst system. The polymerization can be carried out, for example, in bulk phase using a liquid monomer (e.g., propylene) as a reaction medium, in slurry using an inert liquid (e.g., hydrocarbon) as a diluent, in solution using either monomers or inert hydrocarbons as solvent for polymerization, or in gas phase, operating in one or more fluidized or mechanically agitated bed reactors.

Co-polypropylene polymer compositions disclosed herein may include one or more additives in one or more stages of a polymerization process and/or before or after polymerization. Suitable additives may include mechanical and rheological modifiers such as carbon nanomaterials including carbon nanotubes, graphene, fullerenes, diamond-like carbon, or carbon black, fibers, nanocrystalline cellulose, cellulose nanofibrils, silica, silica-alumina, alumina such as (pseudo) boehmite, gibbsite, titania, zirconia, cationic clays or anionic clays such as saponite, bentonite, kaoline, sepiolite, hydrotalcite, and the like. Additives may also include metal oxides such as alumina trihydrate (ATH), aluminum monohydrate, magnesium hydroxide, magnesium silicate, talc, silicas such as fumed silica and precipitated silica, and calcium carbonate, calcium metasilicate, Wollastonite, Dolomite, Perlite, hollow glass spheres, kaolin, and the like.

Other additives may include fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); nucleators (e.g., aromatic carboxylic-acid salts, organic derivatives of dibenzylidene sorbitol, organophosphate salts, inorganic material lacking polymeric solubility); anti-cling additives; tackifiers, such as polybutenes, terpene resins, aliphatic and aromatic hydrocarbon resins, alkali metal and glycerol stearates, and hydrogenated rosins; UV stabilizers such as titanium oxide, zinc oxide, benzophenones, benzotriazoles, aryl esters, sterically hindered amines, the like; heat stabilizers; anti-blocking agents; release agents; anti-static agents; pigments; colorants; dyes; waxes; silica; fillers; talc; and the like.

### EXAMPLE EMBODIMENTS

Nonlimiting example embodiments of the present disclosure include:

Embodiment A: A composition comprising: an ethylene/propylene random copolymer comprising an ethylene content of from about 0.1 wt. % to about 0.47 wt. %, a molecular weight distribution of from about 5 to about 20, a plaque haze of from about 10% to about 35%, and a flexural modulus of from about 250 kpsi to about 350 kpsi.

Embodiment B: A method comprising: polymerizing ethylene and propylene monomers to produce an ethylene/propylene random copolymer composition comprising an ethylene content of from about 0.1 wt. % to about 0.47 wt. %, a molecular weight distribution of from about 5 to about 20, a plaque haze of from about 10% to about 35%, and a flexural modulus of from about 250 kpsi to about 350 kpsi.

Embodiment C: A molded article comprising an ethylene/propylene random copolymer composition comprising an ethylene content of from about 0.1 wt. % to about 0.47 wt. %, a molecular weight distribution of from about 5 to about 20, a plaque haze of from about 10% to about 35%, and a flexural modulus of from about 250 kpsi to about 350 kpsi.

Nonlimiting example embodiments A, B, or C may include one or more of the following elements:

Element 1: wherein the composition has a tensile strength of from about 5500 psi to about 6500 psi.

Element 2: wherein the composition has a melt flow rate at 230° C. of from about 2 g/10 min to about 100 g/10 min.

Element 3: wherein the composition has a melt temperature of from about 150° C. to about 170° C.

Element 4: wherein the composition has a crystallinity temperature of from about 100° C. to about 140° C.

Element 5: wherein the composition has a molecular weight of from about 300 kg/mol to about 700 kg/mol.

Element 6: wherein the composition has a Notched Izod impact value at 23° C. of from about 0.5 ft-lb/in to about 1 ft-lb/in.

Element 7: wherein the composition has a tensile strength of from about 5500 psi to about 6500 psi, a melt flow rate at 230° C. of from about 2 g/10 min to about 100 g/10 min, a melt temperature of from about 150° C. to about 170° C., a crystallinity temperature of from about 100° C. to about 140° C., a molecular weight of from about 300 kg/mol to about 700 kg/mol, and a Notched Izod impact value at 23° C. of from about 0.5 ft-lb/in to about 1 ft-lb/in.

Embodiments A, B, and C may include any of Elements 1-6 in any combination, or Element 7.

Nonlimiting example embodiment B may further include one or more of the following elements:

Element 8: wherein the polymerizing is in the presence of at least a Ziegler-Natta pro-catalyst.

Element 9; further comprising thermoforming, blow molding, or injection molding the composition.

Embodiment B may include any of Elements 1-6 and 8-9 in any combination, or Element 7 and 8-9 in any combination.

Nonlimiting example Embodiment C may further include one or more of the following elements:

Element 10: wherein the molded article is a packaging product.

Element 11: wherein the molded article is thermoformed, blow molded, or injection molded.

Embodiment B may include any of Elements 1-6 and 10-11 in any combination, or Element 7 and 10-11 in any combination.

To facilitate a better understanding of the aspects of the present disclosure, the following examples of preferred or representative aspects are given. In no way should the following examples be read to limit, or to define, the scope of the disclosure.

### Example

In the following examples, various experiments were performed and measurements taken to evaluate and validate the improvement in strength and toughness, as well as clarity, of the co-polypropylene polymer compositions described herein having a broad molecular weight and low ethylene content.

Samples EX1 and EX2 were prepared according to Table 1 below. EX1 and EX2 were compounded using a ZSK 45 mm twin-screw extruder.

TABLE 1

| | | Melt Flow | IRGANOX ™ | IRGAFOS ™ | | |
|---|---|---|---|---|---|---|
| | Ethylene | Rate | 1010 | 168 | Nucleator | Total |
| | (%) | (g/10 min) | (ppm) | (ppm) | (ppm) | (lb) |
| EX1 | 0.49 | 2.83 | 1500 | 1500 | 2855 | 800 |
| EX2 | 0.42 | 2.78 | 1500 | 1500 | 2855 | 800 |

Each of EX1 and EX2 were tested for the qualities provided in Table 2 below, and according to the methods described herein. Each of EX1 and EX2 was compared to commercially available PP6272NE1, a nucleated polypropylene homopolymer (ExxonMobil™, Texas), labeled as “CT” in Table 2.

TABLE 2

| | EX1 | EX2 | CT |
|---|---|---|---|
| MFR (g/10 min) | 2.60 | 2.31 | 2.6 |
| Tm (° C.) | 159.9 | 161.4 | 160.0 |
| Tc (° C.) | 122.8 | 124.1 | 123.8 |
| 1 mm Plaque Haze | 29.0 | 30.0 | 28.7 |
| (%) | | | |
| Tensile Strength | 5343.3 ± 6.1 | 5613.4 ± 11.7 | 5390 |
| (psi) | | | |
| Notched Izod | 1.0 ± 0.1 | 0.86 ± 0.0 | 1.2 (TDS) |
| (ft-lb/in) | | | |
| Mw (kg/mol) | 385.8 | 496.4 | 406.1 |
| MWD | 7.23 | 15.15 | 8.68 |
| Ethylene Percent | 0.56 | 0.46 | 0.49 |
| (%) | | | |

As shown in Table 2, as MWD is increased, so too is the stiffness of the co-polypropylene polymer; the flexural modulus of EX2, having a considerably broader MWD compared to EX1 and CT, exhibits a 10.3% increase compared to EX1 and 4.5% increase compared to CT. In both EX1 and EX2, the clarity remained comparable to the CT sample. Accordingly, the co-polypropylene polymer compositions of the present disclosure exhibit increased strength and toughness (stiffness) at low ethylene levels and relatively broad MWDs, without compromising clarity. Such co-polypropylene polymer compositions may be particularly useful in thermoforming, blow molding, and injection molding applications, such as for use in packaging products.

As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is:

1. A composition comprising:
an ethylene/propylene random copolymer comprising an ethylene content of from about 0.1 wt. % to about 0.47 wt. %, a molecular weight distribution of from about 5 to about 20, a plaque haze of from about 10% to about 35%, and a flexural modulus of from about 250 kpsi to about 350 kpsi.

2. The composition of claim 1, wherein the composition has a tensile strength of from about 5500 psi to about 6500 psi.

3. The composition of claim 1, wherein the composition has a melt flow rate at 230° C. of from about 2 g/10 min to about 100 g/10 min.

4. The composition of claim 1, wherein the composition has a melt temperature of from about 150° C. to about 170° C.

5. The composition of claim 1, wherein the composition has a crystallinity temperature of from about 100° C. to about 140° C.

6. The composition of claim 1, wherein the composition has a molecular weight of from about 300 kg/mol to about 700 kg/mol.

7. The composition of claim 1, wherein the composition has a Notched Izod impact value at 23° C. of from about 0.5 ft-lb/in to about 1 ft-lb/in.

8. The composition of claim 1, wherein the composition has a tensile strength of from about 5500 psi to about 6500 psi, a melt flow rate at 230° C. of from about 2 g/10 min to about 100 g/10 min, a melt temperature of from about 150° C. to about 170° C., a crystallinity temperature of from about 100° C. to about 140° C., a molecular weight of from about 300 kg/mol to about 700 kg/mol, and a Notched Izod impact value at 23° C. of from about 0.5 ft-lb/in to about 1 ft-lb/in.

9. A method comprising:
polymerizing ethylene and propylene monomers to produce an ethylene/propylene random copolymer composition comprising an ethylene content of from about 0.1 wt. % to about 0.47 wt. %, a molecular weight distribution of from about 5 to about 20, a plaque haze of from about 10% to about 35%, and a flexural modulus of from about 250 kpsi to about 350 kpsi.

10. The method of claim 9, wherein the composition has a tensile strength of from about 5500 psi to about 3500 psi.

11. The method of claim 9, wherein the composition has a melt flow rate at 230° C. of from about 2 g/10 min to about 100 g/10 min.

12. The method of claim 9, wherein the composition has a melt temperature of from about 150° C. to about 170° C.

13. The method of claim 9, wherein the composition has a crystallinity temperature of from about 100° C. to about 140° C.

14. The method of claim 9, wherein the composition has a molecular weight of from about 300 kg/mol to about 700 kg/mol.

15. The method of claims 9-14, wherein the composition has a Notched Izod impact value at 23° C. of from about 0.5 ft-lb/in to about 1 ft-lb/in.

16. The method of claim 9, wherein the polymerizing is in the presence of at least a Ziegler-Natta pro-catalyst.

17. The method of claim 9, further comprising thermoforming, blow molding, or injection molding the composition.

18. A molded article comprising an ethylene/propylene random copolymer composition comprising an ethylene content of from about 0.1 wt. % to about 0.47 wt. %, a molecular weight distribution of from about 5 to about 20, a plaque haze of from about 10% to about 35%, and a flexural modulus of from about 250 kpsi to about 350 kpsi.

19. The molded article of claim 18, wherein the molded article is a packaging product.

20. The molded article of claim 18, wherein the molded article is thermoformed, blow molded, or injection molded.
